(19) United States
(12) Patent Application Publication
(10) Pub. No.: US 2011/0086739 A1
(43) Pub. Date: Apr. 14, 2011

(54) HYBRID DRIVE DEVICE

(75) Inventors: Naoki KAJIGAI, Anjo-shi (JP); Yasuo Shirai, Chiryu-shi (JP)

(73) Assignee: AISIN SEIKI KABUSHIKI KAISHA, Kariya-shi (JP)

(21) Appl. No.: 12/888,441

(22) Filed: Sep. 23, 2010

(30) Foreign Application Priority Data
Oct. 9, 2009 (JP) 2009-235562

(51) Int. Cl. B60W 10/08; B60W 10/02; B60W 20/00

(52) U.S. Cl. 477/5; 477/3; 180/65.265

(57) ABSTRACT

A hybrid drive device includes a fluid clutch including an inputting element to which an engine torque outputted from an engine is inputted and an outputting element connected to an input shaft of a transmission to integrally rotate therewith for outputting the torque to the input shaft, the fluid clutch transmitting the torque between the inputting element and the outputting element via a fluid either with or without incrementing the torque, and a motor generator connected to the input shaft for outputting a motor torque to the input shaft to drive the transmission.

### CROSS REFERENCE TO RELATED APPLICATIONS

This application is based on and claims priority under 35 U.S.C. §119 to Japanese Patent Application 2009-235562, filed on Oct. 9, 2009, the entire content of which is incorporated herein by reference.

### TECHNICAL FIELD

This disclosure relates to a hybrid drive device.

### BACKGROUND DISCUSSION

A known hybrid drive device includes an engine and a motor which serve as driving sources, and an automatic transmission including a planetary gear mechanism which is driven by a torque generated by the engine and/or the motor. JP2002-103998A (Patent reference 1) and JP2007-230341A (Patent reference 2) disclose hybrid drive devices which further include a torque converter for multiplying a torque, which is provided between the engine and the automatic transmission.

According to the hybrid drive devices disclosed in Patent reference 1 and Patent reference 2, the motor is connected to a power transmission path between an output of the engine and an input of the torque converter, that is, to a power transmission path between a crankshaft and a pump impeller.

According to the constructions of the hybrid drive devices disclosed in Patent reference 1 and Patent reference 2, because the motor is positioned between the engine and the torque converter, a dimension of a housing which accommodates the hybrid drive device is increased between the engine and the torque converter, particularly, in a radial direction. More specifically, in a case where a damper mechanism, or the like, is arranged between the engine and the torque converter, the dimension of the housing is further increased in a radial direction between the engine and the torque converter.

A need thus exists for a hybrid drive device which is not susceptible to the drawback mentioned above.

### SUMMARY

In light of the foregoing, the disclosure provides a hybrid drive device, which includes a fluid clutch including an inputting element to which an engine torque outputted from an engine is inputted and an outputting element connected to an input shaft of a transmission to integrally rotate therewith for outputting the torque to the input shaft, the fluid clutch transmitting the torque between the inputting element and the outputting element via a fluid either with or without incrementing the torque, and a motor generator connected to the input shaft for outputting a motor torque to the input shaft to drive the transmission.

According to another aspect of this disclosure, a hybrid drive device includes a fluid clutch including a pump impeller to which an engine torque outputted from an engine is inputted and a turbine runner connected to an input shaft of a transmission to integrally rotate therewith for outputting the torque to the input shaft, the fluid clutch transmitting the torque between the pump impeller and the turbine runner via a fluid, a lock-up clutch positioned between the engine and the pump impeller, and a motor generator connected to the input shaft for outputting a motor torque to the input shaft to drive the transmission.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a view showing a power train of a hybrid drive device according to a first embodiment disclosed here;

FIG. 2 is a cross-sectional view of the hybrid drive device illustrated in FIG. 1 in which a motor generator is provided within a transmission;

FIG. 3 is a cross-sectional view of the hybrid drive device illustrated in FIG. 1 in which a motor generator is provided within a PTO housing;

FIG. 4 is a view showing a power train of a hybrid drive device according to a second embodiment disclosed here; and

FIG. 5 is a cross-sectional view of the hybrid drive device illustrated in FIG. 4 in which a motor generator is provided within a transmission.

### DETAILED DESCRIPTION

Embodiments of the hybrid drive device will be explained with reference to illustrations of drawing figures as follows.

The hybrid drive device according to the embodiments includes an input clutch which is connected between an engine and an input element (e.g., pump impeller) of a fluid clutch (e.g., torque converter) and is configured to connect and disconnect a torque transmission between the engine and the input element of the fluid clutch. According to this construction, in a case where an engine torque is not required, for example, when a motor generator performs a regeneration, by disconnecting the input clutch (i.e., released state), a reverse driving force from a vehicle axle is inputted to the motor generator without being absorbed by the engine, which enhances efficiencies of the regeneration. Further, when the vehicle is in motion where there is no request for engine torque, an amount of fuel consumption can be reduced by disconnecting the input clutch and stopping the engine.

According to the hybrid drive device of the embodiments, the motor generator is positioned at a space formed between an input side housing which accommodates the fluid clutch and a transmission housing which accommodates the transmission. According to this construction, because the motor generator is arranged at a dead space positioned between a torque converter and the transmission, an increase of a size of the housing between the engine and the torque converter can be prevented. Further, with a vehicle having a PTO (power takeoff), the motor generator may be positioned within a housing of a PTO mechanism. Accordingly, a body of the hybrid drive device can be compactly housed in the housing of the transmission.

According to the hybrid drive device of the embodiments, the motor generator is positioned outside the transmission housing which accommodates the transmission and the input side housing which accommodates the fluid clutch, a power takeoff gear which integrally rotates with an input shaft of the transmission is provided on the input shaft of the transmission, and a motor torque is transmitted from the motor generator outside the transmission housing to the input shaft provided in the transmission housing. According to this construction, an increase of the housing of the transmission in size is prevented, and a dead space in the vicinity of the PTO apparatus can be efficiently used.

The hybrid drive device according to the embodiments includes an oil pump which supplies a hydraulic pressure to plural engaging elements which achieve each of gear shift stages of the transmission. The oil pump is actuated by one of an impeller shaft which integrally rotates with the input element of the fluid clutch, a fluid clutch cover which integrally rotates with the input element of the fluid clutch, and the input shaft of the transmission. Thus, according to the disclosure, various driving systems for the oil pump are adoptable.

According to the hybrid drive device of the disclosure, a torque converter, which multiplies a torque, or a fluid coupling, which transmits a torque as it is, can be adopted.

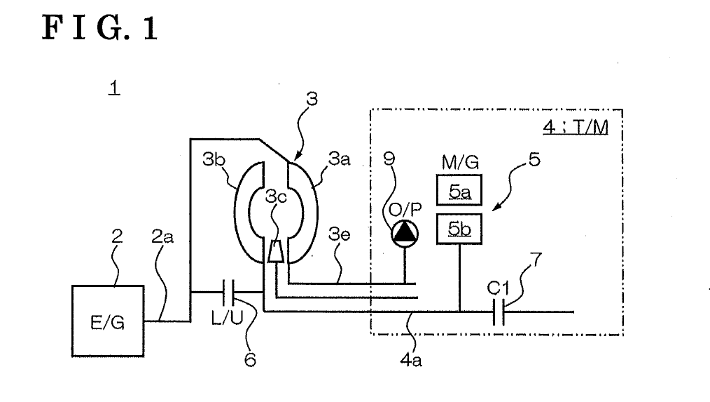

A first embodiment will be explained with reference to FIGS. 1-3 as follows.

Referring to FIG. 1, a hybrid drive device 1 includes a torque converter (i.e., serving as a fluid clutch) 3 and a motor generator 5. The torque converter 3 includes a pump impeller (i.e., serving as an input element) 3a to which an engine torque outputted from an engine (E/G) 2 is outputted, a turbine runner (output element) 3b which outputs a torque to an input shaft 4a of a transmission (T/M) 4, and a stator 3c positioned between the pump impeller 3a and the turbine runner 3b. The torque converter 3 increases a torque between the pump impeller 3a and the turbine runner 3b via a fluid and transmits the increased torque. The motor generator 5 is configured to output a motor torque for driving the transmission 4. Various available transmissions may be applied as the transmission 4, including existing transmissions and upcoming transmissions, without any limitation.

According to the hybrid drive device 1, the turbine runner 3b is connected to the input shaft 4a of the transmission 4 so as to integrally rotate with the input shaft 4a. The motor generator 5 is connected to the input shaft 4a of the transmission 4 so as to output a motor torque to the input shaft 4a of the transmission 4. Particularly, a stator 5a of the motor generator 5 is fixed to an inner wall of a motor housing 12b, and a rotor 5b of the motor generator 5 is connected to the input shaft 4a of the transmission 4 to output the motor torque to the input shaft 4a of the transmission 4, for example, via a motor output gear and a clutch drum meshed with the motor output gear.

A lock-up clutch 6 which is configured to directly connect a crank shaft 2a corresponding to an output shaft of the engine 2 and the turbine runner 3b is arranged between the crank shaft 2a and the turbine runner 3b. An oil pump (O/P) 9 which supplies a lubrication oil to the transmission 4, or the like, is driven by an impeller shaft 3e which integrally rotates with the pump impeller 3a of the torque converter 3.

Functions of the hybrid drive device according to the first embodiment will be explained, for example, an operation when a vehicle to which the hybrid drive device is mounted starts moving will be explained. Referring to FIG. 1, when a vehicle is started (driven) in a normal condition, the transmission 4 is shifted to a low speed stage, normally, a first speed stage. When the motor generator 5 outputs a motor torque in the foregoing state, the motor torque is transmitted from the rotor 5b to the input shaft 4a to drive the transmission 4 which is at the low speed stage smoothly. Further, when a torque request for the hybrid drive device by a driver (i.e., by an acceleration) is increased, the lock-up clutch 6 is directly connected, and the engine 2 starts running by the motor torque.

In a case where a capacity of a battery which supplies a power to the motor generator 5 declines and it is difficult to directly drive the transmission 4 by the motor torque, the transmission 4 is shifted to a neutral state and the lock-up clutch 6 is directly connected to start the engine 2 by the motor torque, so that the transmission 4 is assumed to be able to start by the engine operation.

Further, during the regeneration, the reverse driving force from the vehicle axle is transmitted to the rotor 5b of the motor generator 5 via the input shaft 4a of the transmission 4 to rotate the rotor 5b, thus generating an electromotive force at the stator 5a.

According to the hybrid drive device 1 of the first embodiment, the transmission 4 and the engine 2 start running or the regeneration is executed by the single motor generator 5. According to the hybrid drive device 1 of the first embodiment, the transmission 4 and the engine 2 start running or the regeneration is executed by the single motor generator 5 using the existing transmission 4.

Constructions of the hybrid drive device 1 according to the first embodiment will be explained in terms of accommodating construction as follows.

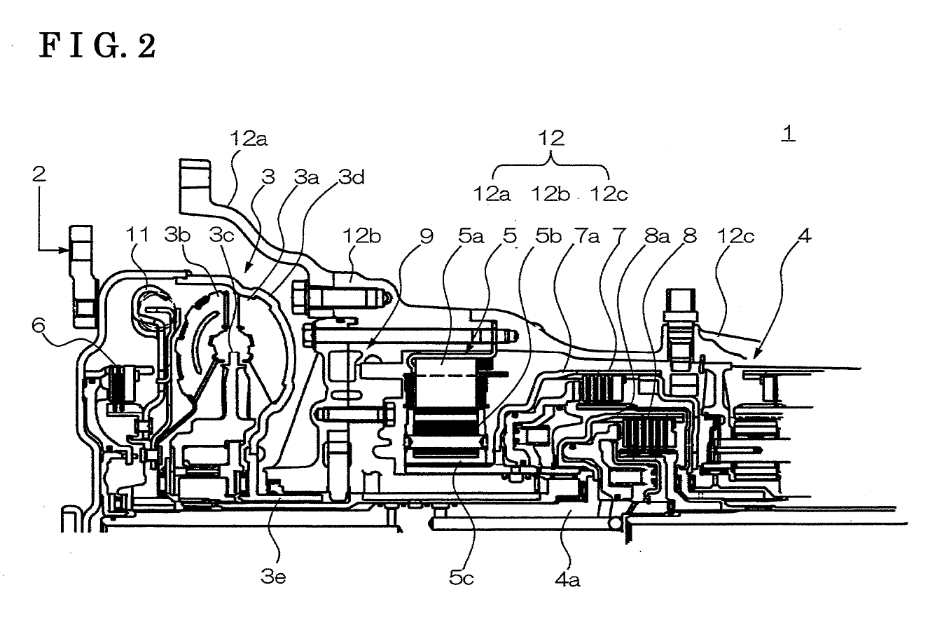

As shown in FIG. 2, a housing 12 of the hybrid drive device 1 includes an input side housing 12a, a transmission housing 12c, and the motor housing (adaptor) 12b connected between the input side housing 12a and the transmission housing 12c in an axial direction. The input side housing 12a accommodates the torque converter 3 and a damper mechanism 11 connected between the turbine runner 3b and the input shaft 4a. The transmission housing 12c houses the transmission 4 which includes a planetary gear mechanism, a clutch, and a brake.

The motor housing 12b covers an outer periphery of the rotor 5b and the stator 5a which is fixed to the inner wall of the motor housing 12b. Thus, the motor generator 5 can be arranged in a dead space between the input side housing 12a, which houses at least the torque converter 3, and the transmission housing 12c which houses the transmission 4. Accordingly, an increase of the input side housing 12a in size between the engine 2 and the torque converter 3 shown in FIG. 1 in a radial direction is prevented.

A motor output gear 5c is mounted to the rotor 5b of the motor generator 5 so as to integrally rotate therewith. The motor output gear 5c is geared with a first clutch drum 7a provided at a first clutch (C1) 7. The first clutch drum 7a is connected to the input shaft 4a of the transmission 4 and a second clutch drum 8a provided at a second clutch (C2) 8 so that the first clutch drum 7a integrally rotates with the input shaft 4a and the second clutch drum 8a. The transmission 4 is configured to attain a predetermined gear speed stage by connecting and disconnecting the first and second clutches 7 and 8 and by controlling states of predetermined members of the planetary gear mechanism.

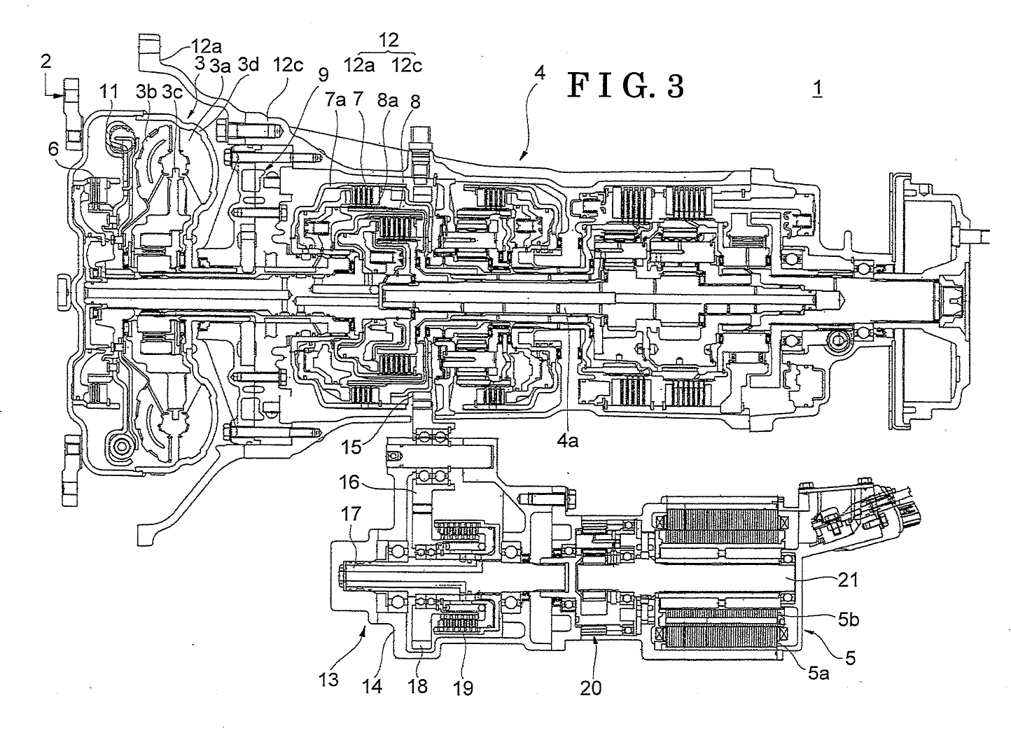

A modification of the first embodiment will be explained as follows. Basically, differences of constructions of the modified example from the first embodiment will be explained, and explanations for the common constructions will not be repeated. As shown in FIG. 3, the motor generator is arranged inside a PTO housing in the hybrid drive device shown in FIG. 1.

Referring to FIG. 3, a PTO housing 14 which accommodates a body of a PTO (power takeoff) mechanism 13 is arranged outside the housing 12 of the hybrid drive device 1. A PTO gear 15 which integrally rotates with the input shaft 4a is mounted to the input shaft 4a of the transmission 4. The PTO gear 15 is geared with a PTO intermediate gear 16. The PTO intermediate gear 16 is geared with a motor output gear 18 which is loosely fitted onto a PTO shaft 17. The motor output gear 18 is fixed so as to integrally rotate with the PTO shaft 17 by a PTO clutch 19. The PTO shaft 17 is connected to a motor shaft 21 which integrally rotates with the rotor 5b via a planetary gear type reduction gear 20. The stator 5a is fixed to an inner wall of the PTO housing 14.

Thus, the motor generator 5 positioned inside the PTO housing 14 is connected to the input shaft 4a of the transmission 4 housed within the transmission housing 12c via the motor shaft 21, the reduction gear 20, the PTO shaft 17, the motor output gear 18, the PTO intermediate gear 16, and the PTO gear 15 so that the motor generator 5 outputs a motor torque to the input shaft 4a when driving the transmission 4 by the motor torque or when driving the engine. In a case of a regenerating process by the reverse driving force from the vehicle axle, torque is transmitted from the input shaft 4a to the motor generator 5.

Accordingly, in a case where the hybrid drive device 1 of the first embodiment is applied to a vehicle including the PTO mechanism, by arranging the motor generator 5 within the PTO housing 14, a dead space existing in an axial direction of the PTO housing 14 is efficiently used to avoid increasing size of the housing 12 of the hybrid drive device 1.

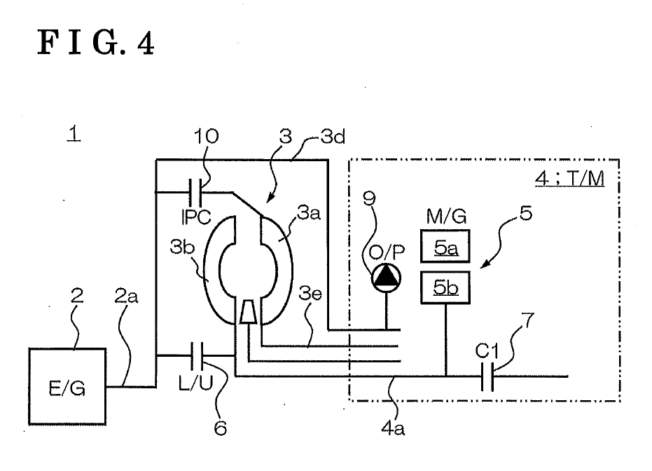

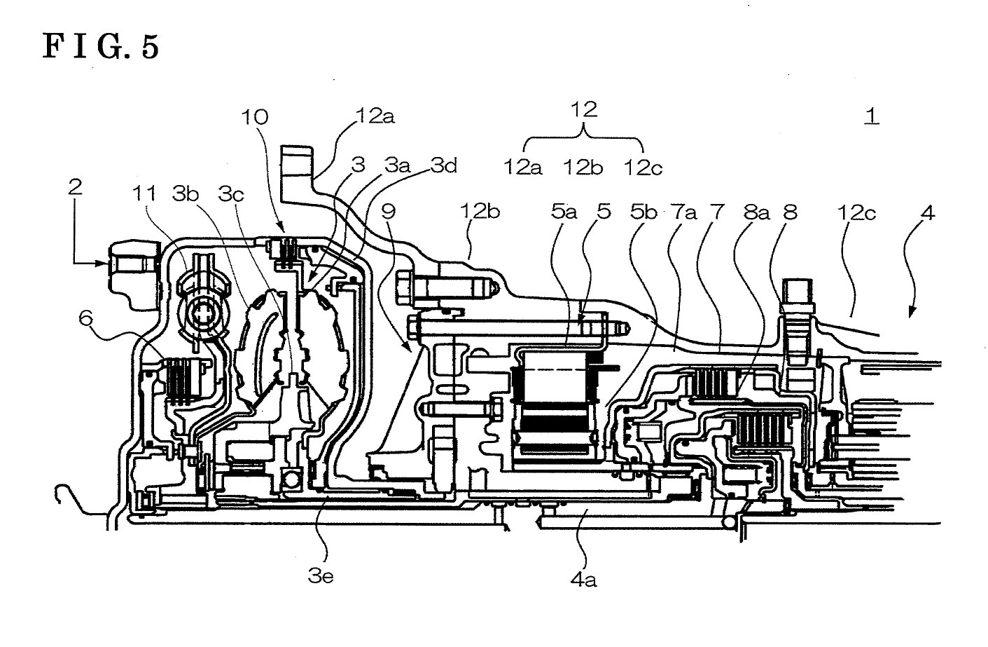

A second embodiment will be explained with reference to FIGS. 4 and 5 as follows. Differences of the hybrid drive device 1 of the second embodiment from the first embodiment will be explained, and explanations for the common constructions to the first embodiment will not be repeated.

As shown in FIG. 4, the hybrid drive device 1 according to the second embodiment includes an input clutch (IPC) 10 which is positioned on a power transmission path between the pump impeller 3a and the crank shaft 2a corresponding to the output shaft of the engine 2. The input clutch 10 is configured to connect and disconnect a torque transmission between the crankshaft 2a and the pump impeller 3a. The oil pump (O/P) 9 is connected to a torque converter cover (fluid clutch cover) 3d which integrally rotates with the pump impeller 3a of the torque converter 3 to be driven.

According to the construction of the second embodiment, in a case where an engine toque is not required, for example, when a regeneration is executed by the motor generator 5, the reverse driving force from the vehicle axle is inputted to the motor generator 5 without being absorbed by the engine 2 by disconnecting (releasing) the input clutch 10, which enhances an efficiency of the regeneration. Further, in a motion state in which a torque is not requested to the engine 2, by disconnecting the input clutch 10 and stopping the engine 2, fuel injection amount (amount of fuel consumption) can be reduced.

Constructions of the hybrid drive device 1 according to the second embodiment will be explained in terms of an accommodating structure as follows. Basically, differences of the construction of the second embodiment from the first embodiment will be explained and common constructions to the first embodiment will not be repeated.

As shown in FIG. 5, the torque converter cover 3d which covers the torque converter 3 is connected to the crankshaft 2a of the engine 2 so as to integrally rotate therewith. The input clutch 10 is arranged between an inner wall of the torque converter cover 3d and an outer periphery portion of the pump impeller 3a in a radial direction.

The hybrid drive device according to the constructions of the embodiments is applied to a hybrid drive device which includes the fluid clutch such as a torque converter or a fluid coupling. Particularly, the hybrid drive device according to the constructions of the embodiments is applied to the hybrid drive device including an automatic transmission. The hybrid drive device according to the constructions of the embodiments is favorably applicable to a hybrid vehicle with a PTO mechanism.

According to the construction of the embodiment, the hybrid drive device 1 includes the input clutch 10 connected between the engine 2 and the pump impeller (inputting element) 3a for connecting and disconnecting a torque transmission between the engine 2 and the pump impeller (inputting element) 3a.

According to the construction of the hybrid drive device 1 of the embodiment, the motor generator 5 is positioned between the input side housing 12a which houses the torque converter (fluid clutch) 3 and the transmission housing 12c which houses the transmission (e.g., automatic transmission) 4.

According to the construction of the embodiment, the hybrid drive device 1 includes the power take off gear 15 provided on the input shaft 4a to integrally rotate with the input shaft 4a. The motor generator 5 is positioned outside the transmission housing 12c which houses the transmission 4 and the input side housing 12a which houses the torque converter (fluid clutch) 3. The motor torque is transmitted from the motor generator 5 provided outside the transmission housing 12c to the input shaft 4a provided within the transmission housing 12c via the power take off gear 15.

According to the construction of the embodiment, the hybrid drive device 1 includes the oil pump 9 supplying the oil pressure to plural engaging elements which establishes each gear speed stage of the transmission 4. The oil pump 9 is driven by one of the impeller shaft 3e which integrally rotates with the pump impeller (inputting element) 3a, the torque converter cover (fluid clutch cover) 3d which integrally rotates with the pump impeller (inputting element) 3a, and the input shaft 4a.

According to the constructions of the embodiments, by connecting the motor generator 5 to the input shaft 4a of the transmission 4 to output a motor torque to the input shaft 4a, the motor generator 5 is arranged at a dead space, for example, between the torque converter 3 (fluid clutch) and the transmission 4. Further, according to the constructions of the embodiment, with the vehicle having the PTO (power takeoff), the motor generator 5 may be arranged within the housing 14 of the PTO mechanism 13. Accordingly, the hybrid drive device 1 of the embodiments is compactly constructed, and an increase of the housing in size is prevented.

According to the constructions of the embodiments, because the hybrid drive device 1 is operable by the single motor generator 5, the number of applied motors is reduced, and thus manufacturing costs are reduced. Further, according to the connecting structure of the motor generator 5, because a motor torque generated by the motor generator 5 is outputted to the input shaft 4a of the transmission 4, an existing power train structure and an existing transmission structure are applicable without any changes. For example, by providing a motor generator to an existing automatic transmission, the hybrid drive device 1 of the embodiments can be attained using the existing power train without newly designing a particular power train.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A hybrid drive device, comprising:
a fluid clutch including an inputting element to which an engine torque outputted from an engine is inputted and an outputting element connected to an input shaft of a transmission to integrally rotate therewith for outputting the torque to the input shaft, the fluid clutch transmitting the torque between the inputting element and the outputting element via a fluid either with or without incrementing the torque; and
a motor generator connected to the input shaft for outputting a motor torque to the input shaft to drive the transmission.

2. The hybrid drive device according to claim 1, further comprising:
an input clutch connected between the engine and the inputting element for connecting and disconnecting a torque transmission between the engine and the inputting element.

3. The hybrid drive device according to claim 1, wherein
the motor generator is positioned between an input side housing which houses the fluid clutch and a transmission housing which houses the transmission.

4. The hybrid drive device according to claim 1, further comprising:
a power take off gear provided on the input shaft to integrally rotate with the input shaft;
wherein
the motor generator is positioned outside the transmission housing which houses the transmission and the input side housing which houses the fluid clutch; and wherein
the motor torque is transmitted from the motor generator provided outside the transmission housing to the input shaft provided within the transmission housing via the power take off gear.

5. The hybrid drive device according to claim 1, further comprising:
an oil pump supplying an oil pressure to a plurality of engaging elements which establishes each gear speed stage of the transmission; wherein
the oil pump is driven by one of an impeller shaft which integrally rotates with the inputting element, a fluid clutch cover which integrally rotates with the inputting element, and the input shaft.

6. A hybrid drive device, comprising:
a fluid clutch including a pump impeller to which an engine torque outputted from an engine is inputted and a turbine runner connected to an input shaft of a transmission to integrally rotate therewith for outputting the torque to the input shaft, the fluid clutch transmitting the torque between the pump impeller and the turbine runner via a fluid;
a lock-up clutch positioned between the engine and the pump impeller; and
a motor generator connected to the input shaft for outputting a motor torque to the input shaft to drive the transmission.

7. The hybrid drive device according to claim 6, further comprising:
an input clutch connected between the engine and the pump impeller for connecting and disconnecting a torque transmission between the engine and the pump impeller.

8. The hybrid drive device according to claim 6, wherein
the motor generator is positioned between an input side housing which houses the fluid clutch and a transmission housing which houses the transmission.

9. The hybrid drive device according to claim 6, further comprising:
a power take off gear provided on the input shaft to integrally rotate with the input shaft;
wherein
the motor generator is positioned outside the transmission housing which houses the transmission and the input side housing which houses the fluid clutch; and wherein
the motor torque is transmitted from the motor generator to the input shaft via the power take off gear.

10. The hybrid drive device according to claim 6, further comprising:
an oil pump supplying an oil pressure to a plurality of engaging elements which establishes each gear speed stage of the transmission; wherein
the oil pump is driven by one of an impeller shaft which integrally rotates with the pump impeller, a fluid clutch cover which integrally rotates with the pump impeller, and the input shaft.
